(19) United States
(12) Patent Application Publication
(10) Pub. No.: US 2002/0008871 A1
(43) Pub. Date: Jan. 24, 2002

(54) Method and device for detecting optical properties, especially luminescence reactions and refraction behavior of molecules which are directly or indirectly bound on a support

(76) Inventors: Annemarie Poustka, Heidelberg (DE); Frank Breitling, Heidelberg (DE); Karl-Heinz Gross, Dossenheim (DE); Stefan Dubel, Dossenheim (DE); Rainer Saffrich, Dossenheim (DE)

Correspondence Address: HENRY M FEIEREISEN, 350 FIFTH AVENUE, SUITE 3220, NEW YORK, NY, 10118

(21) Appl. No.: 09/880,681

(22) Filed: Jun. 13, 2001

Related U.S. Application Data
(63) Continuation of application No. PCT/DE99/03981, filed on Dec. 14, 1999.

(30) Foreign Application Priority Data
Dec. 14, 1998 (DE) 198 57 529.7

(51) Int. Cl. G01J 3/30

(52) U.S. Cl. 356/317

(57) ABSTRACT

According to the method for detecting optical properties, especially luminescence reactions and refraction behavior of molecules which are directly or indirectly bound on a support, electromagnetic waves, especially laser light, are radiated onto the support. The light that is emitted or refracted by the molecules is then detected by a detector. The detector and the support are moved in relation to each other during and after the radiation of the electromagnetic waves. The support used is especially a transparent support with integrated position markings which can be detected by a detector, especially an optoelectronic scanning system. At least one of the integrated position markings is selected while the support and the detector are being moved in relation to each other or thereafter so that the light that is detected by the detector can be associated with a location on the support. A device for carrying out the method is provided with a detector, especially an optoelectronic scanning system, for detecting the position markings that are integrated in the support.

### CROSS-REFERENCES TO RELATED APPLICATIONS

This application is a continuation of prior filed copending PCT International application no. PCT/DE99/03981, filed Dec. 14, 1999.

This application claims the priority of German Patent Application Serial No. 198 57 529.7, filed Dec. 14, 1998, the subject matter of which is incorporated herein by reference.

### BACKGROUND OF THE INVENTION

The present invention relates to methods and devices for detecting optical properties, especially luminescence reactions and refraction behavior, of molecules which are directly or indirectly bound on a support. Here the term “properties” is understood in the broadest sense and should include not only the characteristic properties for specific molecules, such as for example, their mass spectrograms but, for example, also the ability—namely by the mere presence—to exhibit a certain reaction so that the invention thus also relates to such methods and devices for which initially only the mere presence of a substance—but not its type—should be concluded from a certain optical reaction (whereby the type of substance is then determined from its position on the support).

The molecules investigated are constituents of biological structures bound to the support, such as especially cells, molecules, cell parts, cell flagella or tissue or they are bound to biological structures immobilised on the support. The molecules to be investigated comprise all types of molecules particularly relevant in biology, pharmacy and medicine, thus for example, peptides, D-peptides, L-peptides and mixtures thereof, naturally occurring oligonucleotides, their mirror images and mixtures thereof, artificially derivatised oligonucleotides, as used to construct aptamers, oligosaccharides and modifications of said molecules. In particular, modularly constructed oligomers which do not occur naturally can be of particular pharmacological relevance. Particular mention may be made in this context of non-natural substances which can be produced with the aid of chemical combinatorial analysis which can be used as ligands of biological molecules. Ligands of biological molecules can be used, especially organic compounds, steroid derivatives etc. From a plurality of such molecules specific binders can be isolated for a naturally occurring molecule which modify the activity of this molecule. However, since these binders frequently cannot be detached from naturally occurring digestive enzymes, they are especially suitable for use as therapeutics.

Such methods and devices are known in a wide range of forms. An appropriate method is known from German Pat. No. DE 42 33 686 A1. Other similar methods were known from European Pat. No. EP-A-0 819 930, German Pat. No. DE 43 07 042 A and European Pat. No. EP-A-0 376 231. However, these known methods all exhibit various specific disadvantages. The known methods thus require costly and expensive special equipment for their implementation and are comparatively slow in reading out a luminescence signal. In particular, if, as will be explained in detail subsequently, it is advantageous for various reasons to arrange very many molecule groups on a common support and examine them individually, very expensive mechanics must be used to activate the individual molecule groups which is not only costly and liable to breakdown but which in highest precision work also always exhibits manufacturing tolerances several orders of magnitude higher than the minimum size of the molecule groups sufficient for an examination. As a result, the maximum number of molecules or molecule groups which can be accommodated on a support is limited in known methods and devices and is somewhere in the order of magnitude of several 10⁵ molecule groups. For certain blood serum or DNA analyses however, it would be desirable if approximately 10⁸ to 10⁹ molecules could be accommodated on a support and examined.

Lithographic methods are known for applying molecules to the appropriate supports, especially to so-called “diagnostic chips” whereby, however, as in the later investigation, the difficulty of exactly assigning the molecules and the reproducibly purposefully activatable support position limits the maximum number of molecules which can be applied since it is not sufficient to arrange very many different molecules closely packed on a support without however knowing with reproducible accuracy which molecules are in which position on the support. In particular, in known methods and devices it is a problem to read out very many luminescence reactions on a support in a reasonable time and at the same time very accurately. In staining investigations which can be carried out advantageously using the method and devices affected here, in which a material to be examined is applied to the support on which various molecules have already been anchored beforehand, conclusions should be drawn as to the substances present in the material to be examined, such as for example, specific antibodies in a blood serum, with which of the molecules anchored on the support the material or its constituents has formed linkages so that it is necessary to know very exactly which molecule is located where on the support.

Finally, in known devices and methods the molecules once applied can generally not be removed again or only at very great expense. In particular, if a very large number of molecules (a “molecule library”) is located on the support which has been brought in contact with a material to be examined or a mixture of materials (a second “molecule library”, for example, a protein mixture), it would frequently be desirable to purposefully detach from the support the binding partners from the second molecule library, that is the molecules that have formed linkages with molecules of the first molecule library, and submit these for a further examination. This would then make it possible to identify the binding pairs from the two molecule libraries in parallel whereby the binding partner from the first molecule library is in each case known by its position on the support while the binding partner from the second molecule library can be identified after being purposefully detached from the support. It would be particularly advantageous if those support-bound molecules which have bound molecules from the second molecule library could be identified first.

German patent specification 197 52 085 A1 discloses a sample support for the microscopic investigation of a plurality of samples by means of fluorescence spectroscopy in which a plurality of separate recesses forming sample accommodating areas is inserted in one of the side surfaces of a disk-shaped substrate. Using such a sample support however necessitates the ordered arrangement of samples since the position information cannot be read out simultaneously with the fluorescence signal in equally high resolution. In particular, the known sample support cannot be used to detect a cell lawn or irregular structures in a living tissue section on the sample support.

European Pat. No. EP 0 198 513 A2 discloses a device for detecting fluorescence or phosphorescence reactions in which a sample support after excitation of the samples located on it must be rotated in such a way as to avoid erroneous measurements caused by detecting unwanted background fluorescence such that the samples to be examined are located in a different place for detecting the luminescence reactions compared with their excitation. The simultaneous excitation and detecting of luminescence reactions is not possible according to the teaching of said European patent application.

It would therefore be desirable and advantageous to provide improved methods and devices to obviate prior art shortcomings and to detect optical properties, especially luminescence reactions and refraction behavior of molecules bound on a support, especially biological molecules which in addition can be manufactured or implemented at favourable cost. If possible, the methods and devices should also be especially fast to implement or work especially fast.

### SUMMARY OF THE INVENTION

According to one aspect of the present invention, the present invention resolves prior art problems by providing a method for detecting optical properties, especially luminescence reactions and refraction behavior, of molecules bound directly or indirectly on a support, whereby electromagnetic waves, especially laser light, is directed onto the support and light emitted or refracted by the molecules is detected by a detector and whereby detector and support are moved relative to one another during or after the exposure to the electromagnetic waves, whereby a support, especially a transparent support with integrated position markings which can be detected by a detector, especially an optoelectronic scanning system is used and at least one of the integrated position markings is read out during or after the relative movement of the support and detector so that the light detected by the detector can be assigned to a location on the support and the relative movement of the support and detector is produced by rotating the support and a suitably modified, especially transparent compact disk (CD), digital versatile disk (DVD) magneto optical disk (MOD) or fluorescence multilayer disk (FMD) of the type available commercially with respect to the position markings is used.

The relative movement of the support and the detector is achieved by rotating the support. The rotation of the support can even be used in an advantageous further development to make certain desired physical modifications to the support in the manner of a centrifuge. Thus, for example, it is possible to make biological structures provided on the support or fluorescence dyes migrate in an essentially radial direction with respect to the axis of rotation and only then read out the optical properties. Instead of rapid rotation of the support, such movement can be brought about by applying an electromagnetic field or hydrodynamic or osmotic pressure according to the type of substances located on the support.

The invention allows a preferably transparent CD, DVD, MOD or FMD, essentially of the type available commercially with respect to the position markings to be used advantageously as supports. This has the advantage that position detection systems can be used to detect the position of the support, which have already proved very reliable in practice and can also be manufactured at favourable cost. At this point it may be stressed that the concept “integrated position markings” implies all types of markings bound securely to the support, allowing the position of the support to be uniquely determined relative to a detector. In the case of CDs, MODs, DVDs and FMDs quoted as examples of possible supports these markings are integrated in the appropriate supports, whereby in some cases they are not located on the surface where the molecules to be examined are situated but in an underlying layer.

The use of supports whose position markings can be detected optoelectronically has the further advantage that the laser light usually used to read out the markings can also be used at the same time to investigate the molecules, in particular for their luminescence excitation.

The method can be implemented advantageously by measuring the optical properties at a specific location on the rotating support many times one after the other so that, for example, at low signal strength a statistical evaluation can be made or a time variation of the optical properties at a specific location on the support can be detected. Alternatively or additionally, between two measurements of the optical properties at one and the same location on the support it is possible to bleach or deactivate in some other way the fluorescence dyes used to stain the molecules located on the support and then stain the molecules again but with another fluorescence dye.

It is also advantageous if the molecules whose optical properties are to be detected can be exchanged or modified at each location on the support and in particular after exchanging the molecules or modifying the molecules new measurements can be made.

The process of exchanging or modifying molecules whose optical properties are to be detected can be repeated with arbitrary frequency.

Thus a characteristic profile can be compiled for a specific location of the material applied to the support, especially cells or histological sections.

Hereby the optical properties of several different molecules are advantageously measured simultaneously at a specific location.

If the molecules, examined by compiling a characteristic profile for a specific location of the material applied to the support, especially cells or histological sections, or measuring the optical properties of several different molecules at a specific site simultaneously, are released from the support after detecting the optical properties, for detachment of the molecules it is advantageous to use laser light from the same source which also yields the laser light used to investigate the optical properties.

According to another feature of the present invention, the selected molecules or the biological structures carrying the selected molecules, especially liposomes, virus particles, retroviruses, bacteriophages, viroids, cell fragments, especially B-lymphocytes, T-lymphocytes, leucocytes, parasites, single cells or bacteria, are detached from the support especially by exposure to electromagnetic waves, especially laser light, and are supplied to a method for detecting other, not necessarily optical properties. Suitably, the detachment of the selected molecules or the biological structures carrying the selected molecules takes place by interaction of the electromagnetic waves with a preferably meltable or photosensitive substance provided between the support and the molecules or the biological structures. If the molecules examined in this manner are released from the support after detecting the optical properties, for detachment of the molecules it is advantageous to use laser light from the same source which also yields the laser light used to investigate the optical properties. By using suitable supports a single light source can thus take over three different tasks: scanning the position markings, exciting luminescence reactions and detaching molecules. Depending on the type of substances applied to the support, the light source can also be used to trigger light-dependent reactions in the chemicals, biological structures or substances bound to them located in the support.

Since the repeated detecting of optical properties at exactly defined locations on the support is possible according to the invention, various investigations can be carried out one after the other between which surface modifications have taken place in each case, for example, by applying bioactive substances, minerals, binding molecules, antibodies, ligands, receptors, molecules of an extracellular matrix, cell adhesion molecules or other biological structures such as membranes, cells, cell parts, viruses or tissue.

The principle of the confocal laser scanning microscope can be applied when detecting optical properties. Advantageously the fluorescence signals of various image points of an array of molecules are measured in different focussing planes.

In order to enhance the precision and facilitate evaluation, an optical imaging system can be inserted both between the excitation system and the support and between the support and the detection system. Such an imaging system should comprise at least one lens system or an array of lens systems, an optical grating, an optical mirror or an array of optical mirrors, optical fibres or an array of optical fibres and/or a graded-index lens system or an array of graded-index lens systems.

If selected molecules are automatically detached from the support, it can be advantageously provided that the molecules are multiplied before the detection of other not necessarily optical properties, for example, by a polymerase chain reaction or biological replication.

Molecules can be detached from the support in various ways, for example, via a photolabile linker, via ionisation, by electromagnetic radiation, by applying an electrical voltage, via an enzymatic reaction, by changing the ion concentration, by changing the pH or with the aid of a catalyst.

The detached molecules can be constituents of liposomes, virus particles, retroviruses, bacteriophages, viroids or cells, especially D-lymphocytes, T-lymphocytes, leucocytes or bacteria, complexes of nucleic acid and protein, especially of ribosomal display complexes, DNA loaded with DNA-binding fusion proteins, complexes of nucleic acid and other molecules, especially artificially produced complexes of DNA and a ligand.

In another investigation especially a mass spectrogram of the detached molecules can be produced. Advantageously a support can be used to which is applied a preferably complete peptide library containing L amino acids, especially a 4-mer, 5-mer, 6-mer, 7-mer or 8-mer peptide library. Alternatively a peptide library containing D amino acids can also be applied to the support. It is also possible to use supports to which is applied a peptide library of L and D amino acids, an aptamer library, an oligosaccharide library or oligonucleotide library. Such libraries can preferably be applied by means of chemical combinatorial analysis. Moreover the individual monomers of the oligonucleotide library can be mirror images of the naturally occurring monomers.

The method advantageously allows an especially fast analysis of the luminescence behavior of the molecules under study. In addition, it is possible to use a support where the samples are arbitrarily arranged since the position information can be read out simultaneously with the luminescence signal at equally high resolution. Thus, it becomes possible, for example, to detect cell lawns or irregular structures located on the support, such as those present in a tissue section.

The method can be used particularly advantageously as an alternative for fluorescence-activated cell sorters or cell scanners (FACS) with fluorescence-activated cell sorters or cell scanners (FACS) whereby this allows work with adherent cells and, for example, bioactive substances can be used in the screening of molecule libraries. It is also possible to investigate, quickly and easily, epithelia and other exclusively adherently growing cells arranged on the support used so that apoptosis triggers and anti-malarial drugs can be sought. Adherent cells are important in the search for new medicines. The method according to the invention can also be used to quantify without any problems neuronal differentiation processes (axon growth) which only take place on solid matrices and frequently require a special coating of the support.

If a pulsed processor is used, differences in the cell geometry can also be measured. The method thus allows the repeated detection of each individual cell whereas in known FACS the cell under study is lost after the measurement. Thanks to the position information contained in another layer of the support, it is also possible for the first time to measure various properties of one and the same cell one after the other. Also, individual cells in tissue sections attached to the support used can be counted according to specific staining (e.g. migrated T-lymphocytes in biopsies of inflammation foci in auto-immune patients). It is also possible to analyse tumour biopsies, if necessary after repeated staining.

By suitably fast rotation of the support, centrifuging as far as analytical ultracentrifuging can be carried out directly, especially if the support is located in a sealed compartment during the rotation.

In a method for detecting a luminescence reaction of molecules bound to a support, whereby electromagnetic waves, especially laser light, are directed onto the support, provision is made for essentially only that light emitted by the molecules to be detected by the detector. Compared with the known methods which usually work on the principle of the confocal laser scanning microscope, in which some of the scattered exciting light also reaches the detector, this has the advantage that in fact only the emitted light is detected and thus a substantially improved signal-to-noise ratio is achieved.

At this point it may be stressed that the term “light” here means all types of electromagnetic waves, especially therefore also waves having wavelengths outside the range of sensitivity of the human eye.

Now in order to ensure without expensive screens or similar that, as far as possible, only the emitted light reaches the detector or is detected by it, it is possible to proceed on the one hand such that the electromagnetic waves are only directed onto the support for a short time, especially in pulses, and that the detector does not detect any light emitted by the irradiated molecules during the irradiation, whereby here the term “detect” means establishing a measurable quantity including the generation of a suitable signal which can be utilised for the relevant investigation, so that light which does not originate from a luminescence reaction may well reach the actual sensor of the appropriate detector only as long as it is ensured that this light is not converted into perturbing signals, for example, by switching off the detection devices connected to the sensor, especially therefore the signal generation and evaluation during the irradiation of the luminescence-exciting electromagnetic waves.

At this point it may be stressed that by means of the short-term excitation and time-delayed readout of the luminescence reaction in the dark phase of the excitation, the signal-to-noise ratio can be improved for all types of fluorescence measurements, especially for fluorescence measurements using the principle of the confocal laser scanning microscope, in the detection of chromatographically separated fluorescence-marked molecules, especially in DNA sequencing and for fluorescence-activated cell sorters or cell scanners (FACS). This can be achieved alternatively or additionally to the pulsed irradiation of waves by moving the detector and the support relative to one another after or during the irradiation of the electromagnetic waves, especially rotating them relative to one another so that the molecules irradiated by the electromagnetic waves move into a region which can be detected by the detector.

Finally, it is also possible to use several light sources and several detectors which can be switched on and off alternately so that it becomes advantageously possible to excite molecules to luminescence in certain regions on the support by exposure to electromagnetic waves and at the same time or with a time delay to detect any luminescence reaction from other, previously excited regions of the support.

Another method for improving the signal-to-noise ratio of luminescence signals is based on the topography of a mixing array of individually controllable silicon projections with light-emitting diodes. The individually controllable light-emitting diodes are thereby arranged in recesses so that the light emitted by them only excites a luminescence reaction at neighbouring silicon projections. Naturally the topography of the mixing array described can also be combined with short-term excitation of the luminescence reaction and readout of the signals in the dark phase. The short-term excitation of fluorescence molecules also allows fluorescence signals to be assigned particularly simply to individual molecules of a molecule library if these are applied to an array of detectors. The current produced in the dark phases of the excitation as a result of the luminescence of the molecules can be read out in parallel in the various photodetectors and thereby assigned to individual members of the molecule library.

Both as a result of the pulsed irradiation/pulsed detection described and as a result of the movement of the support and detector relative to one another and by the alternate operation of several light sources and detectors, a decoupling of excitation and detection is advantageously achieved which leads to a considerably clearer luminescence signal and thus to an improved signal-to-noise ratio compared with the known methods. The latter can be improved still further by connecting between the support and the detector or detectors one or several wavelength filters which allows any scattered light from the light used for excitation to be separated from the fluorescence light.

In an advantageous method for detecting optical properties of molecules bound on a rotating support, especially molecules bound to biological material, provision is made for directing electromagnetic waves onto the support, observing the irradiated molecules with a detector, automatically detaching selected molecules from the support and transferring these to a second detector for detecting other, not necessarily, optical properties. This method has the advantage that after a first analytical step (e.g. an inherently known staining reaction) in which certain molecules have formed linkages with molecules already bound on the support and new molecule complexes have thus been formed, these new molecule complexes can be purposefully investigated further, whereby a mass spectrogram of the detached molecule complexes can be produced by the second detector.

It is thus possible to proceed by detaching the selected molecules from the support by exposure to electromagnetic waves, especially by exposure to laser light, which can be achieved relatively easily and inexpensively for a very large number of samples.

In an especially advantageous fashion a mixing array of individually controllable silicon projections and light-emitting diodes can be used to detach selected molecules. The individually controllable light-emitting diodes are thereby used to excite neighbouring fluorescence-marked molecules and with the identification of binding events to pre-select which molecules should be detached from the support and transferred to a second detector. If these molecules are located on individually controllable silicon projections, these can be detached from the support very easily, especially by applying an electrical voltage.

Thus, for example, the initially unknown binding partner from a second molecule library to a member from the first molecule library already known because of its position on the support can be determined in the mass spectrometer and indeed, for several members in parallel. The identity of the binding partner from the second molecule library is obtained, for example, by comparing the mass (or tryptic cleavage fragments of a bound protein) with the known sequences of an already sequenced genome. Another example is the detachment of a recombinant phage antibody which has bound a known antibody by its surface-expressed Fv antibody. An E. coli bacterium can be infected with this phage antibody and the recombinant antibody then produced.

Another example is the sequencing of complex DNA by means of solid-phase-linked oligos where a sequencing reaction takes place “in situ” i.e., in parallel for millions of different oligos. The oligo originally linked to the support is thereby modified, it is lengthened by means of a polymerase and a template until a ddNTP built in by the polymerase leads to chain termination.

Instead of the originally linked oligos we obtain a family of somewhat longer oligos which are terminated, for example, by a ddC. This family of modified oligos must be detached from the template (e.g. by heating) and then from the support (for example, by inserting an S=S bridge into the connecting piece to the support which can be detached by reducing agents such as mercaptoethanol). The mass spectrometer then determines the masses of the various members of this family of ddC-terminated oligos and by comparison with the predicted masses the sequence of the lengthening.

An advantageous support to be used according to the invention possesses integrated position markings, as fine-meshed as possible, which can be detected by a detector so that any inaccuracies of the relevant displacement mechanism need no longer lead to incorrect research results since the position markings integrated in the support allow the actual position of the support relative to a detector to be monitored. A commercially available compact disk (CD), digital versatile disk (DVD), magneto optical disk (MOD) or especially a fluorescence multilayer disk (FMD) is used as the support, which already have fined-meshed internal position markings, allowing an exact determination of position to be made using a micrometer whereby the methods for reading and checking the markings on these known supports have already proved very reliable. As a result of the similarity of CD, DVD, MOD and FMD in relation to the properties required here, for simplicity only CD will be specified in the following whereby this should always be taken to include DVD, MOD and FMD.

The CDs and readout equipment which can be used in the method according to the invention are also significantly more favourably priced than the known diagnostic chips.

It is particularly advantageous to use a light-transmitting support in the method described above. This allows laser light used in an inherently known fashion to scan the position markings at the same time to excite luminescence reactions. Alternatively a CD with a wavelength filter integrated in the CD can be used whereby a laser with an inherently known technique for exact fine-meshed position determination can be used whose light does not reach the molecules applied or to be applied on the other side of the CD. Then, another laser whose light can penetrate said wavelength filters can be used for the synthesis or for reading out the luminescence reaction. This second laser is fixed to the first laser such that with the position determination of the first laser the positioning of the second laser beam on the CD is known automatically.

The flat screens used for computers also possess integrated position markings such that the various LED/LCD image points are assigned very exactly determined positions and are individually controllable so that a transparent support for biological materials applied in the immediate vicinity above the light-emitting diodes/liquid crystals can be illuminated at precisely defined points. This applies even more if the liquid crystals used so far are replaced by an array of miniaturised lasers or light-emitting diodes as closely packed as possible.

A particularly advantageous solution is thereby based on the topography of a mixing array of individually controllable silicon projections with molecules applied to them and light-emitting diodes. The individually controllable light-emitting diodes are thereby arranged in recesses such that the light emitted by them only excites a luminescence reaction at neighbouring silicon projections. It is thus possible to have a reproducibly exact assignment of exciting light and applied molecules.

Using an array of microlasers or light-emitting diodes or using said mixing array offers the possibility of keeping the support for biological material fixed above the array throughout an entire cycle, beginning with the preferably lithographic synthesis of the molecule library or synthesis mediated by the application of a voltage, through the staining of the library with a second molecule library as far as the readout of the binding events. This ensures that the individual image points can be located very easily, very rapidly and nevertheless with extremely high and reproducible accuracy, whereby the time-consuming location and focussing of the various image points is eliminated. The possibility of imaging the array of light-emitting diodes or microlasers with the aid of a simple imaging system on the support in reduced form also allows a very high packing density of molecule libraries applied by lithographic synthesis. In addition support and array can then be separated whereupon the array can be re-used.

For example, arrays of photomultipliers, PIN diodes, avalanche diodes or a so-called multichannel plate can be used as detectors. The detectors can also be incorporated in the arrays as excitation light sources whereby mixing arrays of detectors and excitation light sources are formed.

If the molecules to be investigated are applied to one side and the position markings to the other side of the compact disk, this allows the number of molecules which can be arranged per unit area on a support in precisely defined and in particular retrievable positions to be increased enormously compared with the known methods—hitherto it has been possible to arrange approximately 10⁵ molecules on a support of comparable size to the size of a CD such that their position could be determined precisely whereas now 10⁸ to 10¹⁰ can thus be arranged on a CD, exactly located and purposefully examined. The same applies to the use of a type of flat screen, especially if the liquid crystals used so far are replaced by an array of microlasers or light-emitting diodes. The precise position information is obtained in this case by the relative arrangement of the microlasers one to the other so that precisely defined points can be illuminated on a preferably transparent support of molecule libraries arranged parallel above the flat screen. By this means it was possible for the first time to arrange very large molecule libraries on a single, very handy support. For example, a preferably complete peptide library, especially a 4-, 5-, 6-, or 7-mer peptide library can be applied to the support whereby, after applying the peptide library the support can be brought in contact with a blood serum to be examined. In the same way, it is possible to apply to the support a preferably complete oligonucleotide library, especially a 15-mer oligonucleotide library whereby, after applying the oligonucleotide library the support is brought in contact with DNA to be examined, especially fluorescence-marked and multiplied with the aid of random oligonucleotide primers. Thus it is possible for the first time to test a blood serum or DNA sample for very many infectious, autoimmune or hereditary diseases in a single staining reaction, whereby any serum antibodies bound to molecules of the peptide library can be detected in an inherently known fashion by fluorescence-marked anti-human antibodies.

The invention thus creates completely new diagnostic possibilities and especially increases the chances of finding diagnostic markers and therapeutics. If, for example, complete 6-mer peptide libraries are brought in contact with a fairly large number of patient sera and examined, for example, by means of a staining reaction to determine on which peptides serum constituents have deposited, correlations are thus obtained between disease and stained peptides. This assumes that every person carries a very complex individual pattern of antibody reactivities in their blood serum which in particular reflects the conflict of their immune system with acute, chronic or hidden diseases or those already overcome. A large part of the antibody reactivities can be defined by the specific binding to penta- or hexapeptides whereby the afore-mentioned individual pattern of antibody reactivities can be determined in as yet unknown complexity by analysing the binding reactivities to a complete penta- or hexapeptide library. Longer binding motives, especially those occurring frequently with a helical structure, can be determined by libraries in which not every amino acid is random but only those at specific positions derived from the structure. In this way new diagnostic markers and as yet unknown correlations can be found between disease and specific antibody reactivities, including, for example, markers for tumour diseases, cardiovascular diseases such as heart attack, for multiple sclerosis and Parkinson's disease, for all types of autoimmune diseases and allergies and for all types of infectious diseases.

The ensuing pattern of markers itself can, on the one hand, be used to make a diagnostic prediction by the correlation to specific clinical pictures. However the newly found markers can also be applied separately to supports and used for future investigations.

Similarly, attempts can also be made to correlate diseases to binding patterns to other molecule libraries such as D-peptide libraries or oligosaccharide libraries. This method is not limited to human diseases but is also suitable for examining forensic and vetinerary medical questions, and likewise for analysing other fluids, from plant extracts to extracts from micro-organisms.

In another application molecules of potential therapeutic interest, such as, for example, D-peptides which cannot be broken down by human digestive enzymes, are arranged on a support and then brought in contact with medically relevant molecules, especially with pathogen-specific proteins or with mixtures of pathogen-specific proteins. This makes it possible to search purposefully and rapidly for binding partners for these medically relevant molecules. Similarly it is also possible to search for enzyme ligands, enzyme substrate analogues or enzyme inhibitors.

The binding to medically relevant molecules can then be detected, for example, by way of biotinylation or fluorescence marking so that it is possible to identify the D-peptides or aptamers which bind at least parts of the pathogen. These D-peptides or aptamers can then be tested one after the other to determine whether they inhibit the pathogen. If, for example, an enzyme of the pathogen (e.g. HIV protease, reverse transcriptase etc.) is present in a suitable quantity, this enzyme can be fluorescence-marked (either directly or by recombinant expression of a small peptide tag which can be stained using a monoclonal antibody). In this way it can be established to which D-peptides the enzyme has bound. Another staining reaction caused by the enzyme activity is then carried out. For example, the cleavage by the HIV protease precipitates a fluorescing peptide which can be detected. Thus, D-peptides are obtained which not only bind the enzyme but also inhibit it at the same time.

In order to identify on which of the molecules bound to the support molecules have deposited, after or before the support is brought in contact with the blood serum or DNA, the blood serum or DNA is brought in contact with a substance which reacts, more especially forms linkages, with the blood serum or DNA. More suitably, before being brought in contact with the serum or DNA, the substance reacting with the blood serum or DNA is stained with a substance excitable to luminescence, especially a dye excitable to fluorescence by exposure to laser light. Such dyes are available commercially for example, under the names “Cy3”, “Cy5”, “FITC” or “TRITC” whereby advantageously a whole range of conjugates of these fluorescence dyes is already available (e.g. goat anti-human antibody conjugated Cy5).

If the blood serum to be examined is brought in contact with a detection reagent specific for type E immunoglobulin, any existing allergies in the patient can thus be determined since the type E immunoglobulins are responsible for allergic reactions such as asthma and hay fever. Non-allergy sufferers have almost no IgEs in their blood serum while allergy sufferers have various amounts which can reveal different allergens. Finally, the invention makes it possible to search for specific binding partners for a target molecule from a library of 10⁸ to 10¹⁰ different molecules and thus, by simultaneously identifying many (of varying binding strength) binding partners, to search for the structural parameters responsible for the binding of the ligand to the target molecule. By this means the path towards guide structures is simplified substantially. For example, signal patterns obtained using the aforesaid methods can be automatically correlated with structural parameters or structural models of the identified ligands from the library used.

Now, in order to arrange a peptide library on a support, especially on a support which can be used in one of the methods just described, first a surface of the support can be coated with a plastic layer (for the introduction of primary amino groups into polystyrene see FIG. 15) which contains free amino groups for the solid-phase synthesis of a peptide or oligonucleotide library (e.g. the derivatised polystyrene “CovaLink” supplied by Nunc). After inserting a suitable spacer the free amino groups are then blocked with a protective group which can be detached by light. One example of many for an activated, i.e. reactive with amino groups, light-detachable protective group is nitroveratryloxycarbonyl (NVOC).

Then protective groups in certain regions of the support are detached by means of a laser whereupon an activated amino acid whose own amino group is blocked by a light-detachable protective group is applied to the support and distributed there such that the amino acid can link to the free amino groups. Thereafter the process steps “detachment of protective groups in certain regions of the support” and “supply of an activated amino acid whose own amino group is blocked by the light-detachable protective group” are repeated for different, preferably all 20 amino acids and finally the protective groups of all synthesised peptides are detached.

Alternatively another lithographic method for applying a peptide library can be applied. Thus, for example, the perfected conventional standard syntheses (e.g. using fMoc protective groups in peptide synthesis) can be combined with the inclusion of activated monomers in photo- or electrolabile larger particles. The irradiated electromagnetic waves or an applied voltage then do not detach the photo- or electrolabile protective group on the growing oligomer but only release the normal activated monomers such as those used for standard syntheses. The activated monomers are thereby preferably dissolved at higher temperature in a solvent whose melting point or whose transition to a gel-like state occurs near 20° C. whereupon a laser-light-absorbing dye is added, the mixture cooled down and at lower temperature pulverised into small solid particles which are sprayed over the support for the lithographically synthesised molecule libraries. The activated monomers are only released locally from these particles at those places where the laser heats the particles as a result of absorption of the included dye. As a result the particles liquefy or gel and the activated monomers can link to the free amino groups in solution (or to free hydroxyl groups as in oligonucleotide synthesis). The liquid then solidifies again directly near the heated location.

The solid particles are heated particularly advantageously with the aid of a light source repeatedly emitting short-term irradiation, especially a laser or a light-emitting diode whereby particularly sharply defined transitions arise between solid particles and substances released locally from the particles.

Alternatively to melting, a cage inclusion can be used, especially in fullerenes, or another method for release which, for example can be triggered by electromagnetic waves or an electrical voltage.

Alternatively moreover, selected regions can be heated by the repeated application of a voltage in rapid sequence, especially if a mixing array of individually controllable silicon projections with light-emitting diodes is used. Instead of activated monomers, combinations of monomers can also be linked, thus for example all 20×20 possible activated dimers of L amino acids.

In the next step the non-linked monomers, the nonreceptive particles and/or the solidified particles are either simply blown away or dissolved and washed away, more solid particles containing activated monomers are applied, linked to the support in selected regions and this step is carried out preferably with all available different activated monomers one after the other, the standard protective groups newly introduced as a result of the linkings are then detached by known techniques and the next cycle is begun until, for example, a complete peptide library has been synthesised. Additional modifications of different kinds by different chemical reactions are also possible, especially relevant modifications such as glycosylations, phosphorylations or alkylations.

Another possibility when using a mixing array of individually controllable silicon projection with light-emitting diodes is the control of combinatorial molecular synthesis by applying a voltage in selected regions. By this means suitably charged activated monomers for the molecular synthesis are either repelled or attracted to selected regions.

In order to apply an oligonucleotide library to one of the aforesaid supports, a procedure similar to the synthesis of peptide libraries can be followed with the difference that instead of the 20 different activated amino acids, only four different activated nucleotides need be used. For this it is suitable to use four different 3′-O-phosphoramidite-activated deoxynucleosides which have a photolabile protective group at the 5′ end or at the 3′ end or which, included in particles, as described for the synthesis of a peptide library, are scattered over the support and then mobilised by exposure to electromagnetic waves. The free hydroxyl groups normally used for the oligonucleotide synthesis can also be introduced at the same time with the insertion of a suitable spacer.

Similar methods can also be used to produce aptamer libraries, i.e. for oligomers based on ribonucleotides and their derivatives. In addition, reactive molecules of another kind, as used for example in combinatorial chemistry, are included in the activatable particles and released in specific locations. Thus, in addition to nucleotides or amino acids numerous other groups can be used as monomeric combinable building blocks for oligomer synthesis.

Alternatively a molecule library can be applied to the support by one of numerous printing or spot methods, as for example, by means of a nozzle similar to that used in an ink jet printer. Then selected regions of the support can be irradiated with laser light or with the aid of light-emitting diodes such that in these regions the applied molecules become anchored on the support. This is especially advantageous because as a result, a luminescence signal is later excited and read out in precisely the same region in which the previously applied molecules were anchored as a result of the activity of the exciting laser.

In order to achieve this, for example, before applying the molecules to be anchored a substance which is solid at the appropriate ambient temperatures can be applied to the support, which is then melted to anchor the molecules. It is thus possible to proceed by activating the surface of a support (e.g. by uniform chemical linking of streptavidin or biotin on the entire support), then applying at 40° C. a solvent containing dye molecules which is solid at 10° C. (if necessary, hydrophobic if hydrophilic molecules are to be linked) uniformly to the support and letting it solidify there, whereupon the molecules to be linked are applied to the support, selected regions of the support are heated by means of laser, light-emitting diodes or voltage as a result of which the solvent liquefies or volatilises locally and the molecule applied for linking can be bound to the support. The binding takes place preferably via biotin-streptavidin. Then non-bound molecules are washed away and the cycle can begin with a new spot or printing process until a closely packed and complex molecule library is applied to the support.

However, the application or synthesis of a molecule library on a support is not restricted to the methods described; other methods may be mentioned for example:

spotting of microquantities of molecules using a principle comparable to that of the fountain pen, especially PCR products of multiplied gene sequences;

spotting of microquantities using a type of screen printing method, especially activated monomers for oligonucleotide synthesis, synthesis of peptides or synthesis of PNAs;

spotting of microquantities using an ink jet printer, especially activated monomers for oligonucleotide synthesis, synthesis of peptides or synthesis of PNAs;

synthesis of PNAs, whereby at each point in the polymerisation cycles or after printing the molecules other compounds can be attached or the molecules already linked can be modified.

According to another aspect of the present invention, a device suitable for solving the problem specified initially may include an assembly for directing the electromagnetic waves, especially laser light, on the support; a detector for detecting light emitted or refracted by the molecules; and an assembly for producing a relative movement of detector and support during or after the exposure to electromagnetic waves, wherein a detector, especially an optoelectronic scanning system is provided to detect position markings integrated in the support.

According to another aspect of the present invention, a support for implementing the method may be a transparent CD, DVD, MOD or FMD, essentially of the type available commercially with respect to the position markings.

A particularly advantageous embodiment is based on the topography of a mixing array of individually controllable silicon projections with molecules applied to them and light-emitting diodes. The individually controllable light-emitting diodes are arranged in recesses so that light emitted by them only excites a luminescence reaction at neighbouring silicon projections. In this way a precise, especially short-term excitation of selected regions is repeatably detectable. This embodiment even offers the possibility of assigning a voltage change produced by the luminescence signal directly to each individual silicon projection so that in this case the molecule support is identical to the detector.

As a result of the short-term excitation of fluorescence molecules, the purposeful luminescence excitation of selected regions can also be dispensed with if the various molecules of a molecule library are applied to an array of detectors. In this case, excitation can preferably be provided by a pulsed laser whose light is detected by a larger number of detectors. The current produced in the dark phases of the excitation as a result of the luminescence of the molecules can then be read out in parallel in the various photodetectors and thereby assigned to various members of the molecule library.

Spatial decoupling of excitation and detection can also be accomplished very easily in the case of excitation by an array of microlasers and light-emitting diodes by means of a relatively coarse grid of detectors which detect the luminescence scattered in all spatial directions of the molecules excited by the exciting laser. For this purpose only the single detector which detects the light emitted by the exciting laser must be gated. Naturally the time decoupling of excitation and detection can be combined with the spatial decoupling.

In another embodiment of a device for detecting optical properties of molecules bound on a support, especially biological or biologically relevant molecules, with means for directing electromagnetic waves onto the support and a detector for observing the irradiated molecules, means are provided for detaching selected molecules which then especially makes it possible to advantageously detach molecules purposefully from the support if these have been selected in a first analytical step. The detached molecules can then be supplied to a further examination, especially a detector of a second type, e.g. a spectrometer, especially a mass spectrometer with which specific properties of the detached molecules can be detected.

The means for detachment in an advantageous further development of said device can be a laser. However it is especially simple and advantageous to use for this purpose an electrically controllable and chargeable support whereby the molecules bound to the support in selected regions can be detached very easily by applying a voltage.

As supports for molecules, especially biological molecules, especially for use in one of said methods it is possible to use supports according to the invention which exhibit a fine-meshed network of position markings so that it is possible to monitor the position of a location to be examined which has been activated on the support, for example, by means of conventional mechanics, with a detector. Preferably these position markings are designed so they can be detected by an optoelectronic scanning system.

If an essentially commercially available compact disk is used as a support, as well as cost advantages over known diagnostic chips this has the advantage that essentially commercially available equipment, especially read and write lasers provided in CD players and CD burners can be used to investigate the support. If the compact disk is then made transparent to light, the laser light can be used not only for optoelectronic position detection but also at the same time to excite luminescence reactions of molecules bound on the CD. Alternatively CDs or analogue media with a wavelength filter built in the CD can be used whereby a laser whose light cannot penetrate the wavelength filter is used for the precise positioning of the CD while a second laser whose light can penetrate the wavelength filter can be used for repeated locally precise synthesis or excitation of a luminescence reaction as a result of its fixed distance from the first laser.

Similar advantages are achieved by using an array of microlasers or light-emitting diodes to excite the luminescence reaction. The precise position information is obtained in this case by the relative arrangement of the microlasers relative to each other so that precisely defined points on a preferably transparent support of molecule libraries arranged parallel over the array can be illuminated repeatedly, almost arbitrarily frequently. The support can consist of almost any material, especially derivatised glass for the synthesis of a molecule library.

Especially for the lithographic synthesis of a molecule library when using an array of microlasers or light-emitting diodes, the support of the molecule library can be especially advantageously fixed above the array. In addition, another array of detectors can be fixed thereto, which in particular makes it possible to calibrate the desired single signal with a uniformly fluorescence-marked support.

The same also applies to the mixing array of individually controllable silicon projections (with the molecules applied thereto) with light-emitting diodes. Such mixing arrays can also be fixed to a detector or an array of detectors if not merely the voltage change produced by a luminescence signal is assigned directly to each individual silicon projection, so that in this case the support of the molecules is identical to the detector. This ensures very simple and nevertheless extremely accurate, repeatable location of the various image points during the lithographic synthesis of the molecule library or synthesis controlled by the application of a voltage and the subsequent staining and readout steps and in addition there is no time-consuming control and focussing of the various image points. As a result of the absence of any moving parts, such an embodiment is particularly robust and simple to handle.

Highly complex molecule libraries, e.g. a peptide library, especially a preferably complete 4-, 5-, 6- or 7-mer peptide library or an oligonucleotide library, especially a preferably complete 12-, 13-, 14- or 15-mer oligonucleotide library or aptamer library can be applied to the support so that the position of the various molecules or molecule groups from several molecules of one molecular species can repeatedly be precisely activated and thus can be purposefully examined.

In order to apply molecules to an essentially flat surface of a support, a device is proposed according to the invention which comprises means for holding the support such that it can be rotated about an essentially perpendicular axis of rotation to said surface of the support, means for applying various fluids to the surface of the support in the region of the axis of rotation and at least one laser which can be moved relative to the support to irradiate selected regions of the support with laser light.

When using an array of microlasers or light-emitting diodes, a suitable preferably transparent support is brought into the light beam of the light sources and fixed there. The precise position information is obtained in this case by the relative arrangement of the microlasers or light-emitting diodes relative to one another so that precisely defined points on the support can be repeatedly illuminated. This can be utilised especially for lithographic synthesis and the subsequent readout of molecule libraries.

If the molecule libraries are applied to the support independently of the activity of the exciting laser(s), suitably detectable “guide dots” arranged regularly with respect to the applied molecule library are used as reference points to determine the position of the various applied molecules.

Alternatively, a device can also be used for this purpose where there is provided nozzle-like means for applying extremely small quantities of molecules to be anchored to the support, means for moving the means for applying the molecules and the support relative to one another and at least one laser to irradiate selected regions of the support with laser light.

Alternatively molecules or molecule libraries can be applied to the supports using various already known printing methods, e.g., using a modified screen printing method. PCR fragments are, for example, printed on instantaneously using the principle of a fountain pen. The latter indeed allows highly complex molecule libraries to be synthesised but in printing methods the various spots must be matched to the readout mechanism which is very time-consuming since each spot must be activated and generally focussed through until finally the setting giving the maximum light yield is selected, which is unnecessary when using a CD or an array of microlasers or light-emitting diodes since, especially with an array of microlasers, the various image points are irradiated with almost parallel light. The same applies if an array of detectors is used as molecule supports.

With a CD or similar supports said problem is also very much mitigated because of the extremely fine-meshed network of position information since there is always a pit in the immediate vicinity relative to which the molecules can be anchored on the support and read out.

Especially if an array of individually controllable silicon projections or a mixing array with light-emitting diodes as described above is used as molecule supports, printed-on molecules can be applied to the support by means of a voltage applied in selected regions if the molecules to be applied have a suitable charge or were ionised with the aid of purposefully controllable light sources in selected regions.

The invention thus allows the specialist to select the most suitable device for applying the relevant molecules to the relevant supports whereby in individual cases he can combine both devices and can first apply one part of the molecules to the support with one device and then apply another part of the molecules with the other device.

### BRIEF DESCRIPTION OF THE DRAWING

Other features and advantages of the present invention will be more readily apparent upon reading the following description of preferred exemplified embodiments of the invention with reference to the accompanying drawing, in which:

FIG. 1 is a schematic illustration, depicting the operating principle of a device for detecting a luminescence reaction of biological molecules;

FIG. 2 is a schematic illustration, depicting the use of an array of microlasers;

FIGS. 3-5 is a schematic illustration, depicting a linkage of nucleosides to the free amino groups;

FIGS. 6 and 7 show steps of a method according to the present invention;

FIG. 8 is a schematic illustration, depicting an example the basic principle of the method according to the present invention;

FIGS. 9 and 10 are schematic illustrations, depicting a physical environment, especially of the matrix layer of substances in locally narrowly defined regions;

FIG. 11 is a schematic illustration of another step of the method according to the present invention;

FIG. 12 shows a suitably designed mixing array of individually controllable light sources and detectors;

FIGS. 13 and 14 show schematically an array of individually controllable detectors to trigger combinatorial molecular synthesis in selected regions; and

FIG. 15 illustrates primary amino groups for introduction into polystyrene.

### DETAILED DESCRIPTION OF PREFERRED EMBODIMENTS

Throughout all the Figures, same or corresponding elements are generally indicated by same reference numerals.

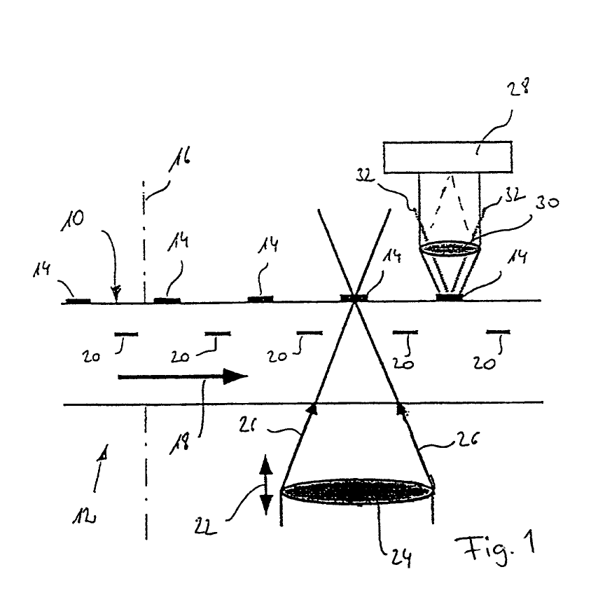

FIG. 1 shows the operating principle of a device for detecting a luminescence reaction of biological molecules 14 bound to the upper side 10 of a support 12 whereby the support 12 rotates about an axis of rotation 16 perpendicular to the upper side 10, as indicated by the arrow 18. Here the support 12 is an essentially commercially available CD which is however designed to be transparent to light and is provided on its side opposite the upper side 10 with recesses, so-called “pits” which are indicated by the dashes 20 and are located beneath a transparent protective layer.

The pits form internal position markings which can be read by the optoelectronic detection system of a conventional CD player or CD burner which is merely indicated here. The detection system is known to comprise essentially a laser not shown here and an adjustable or movable focussing coil or lens 24, as indicated by the direction arrow 22, which allows the rays 26 produced by the laser to be used advantageously both to scan the pits 20 and thus to determine positions and also, as at the time shown in the FIG., to irradiate and possibly excite the molecules 14 through the CD.

After the site of irradiation in the direction of movement of the CD there is inserted a light-sensitive detector 28 to which is assigned a lens 30 which focuses light rays 32 emitted by any excited molecules and directs them onto the detector 28. This arrangement ensures that the laser light does not perturb the detection process by overlapping. In addition, luminescence reactions of excited molecules can be detected in this way while at the same time new molecules are already being irradiated so that the investigation of molecules arranged on the CD can be carried out advantageously at very high speed.

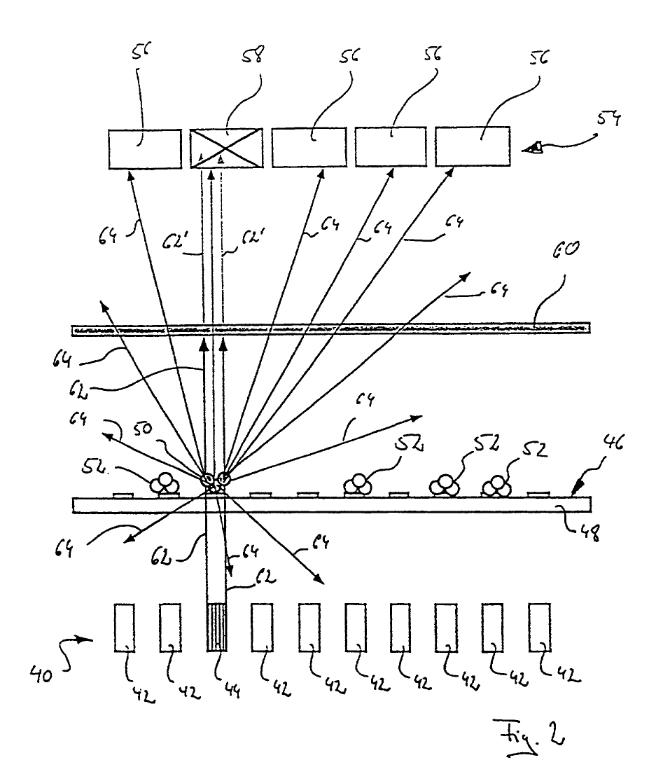

FIG. 2 shows the use of an array 40 of microlasers 42, 44 to excite molecules 50, 52 bound on a flat side 46 of a support 48. Since the microlasers are individually controllable and arranged in specified positions relative to one another, precisely defined points can be illuminated on the transparent support 48 which is fixed parallel above the array 40 in the example shown and the molecules located there can be excited to luminescence as appropriate. Thus, at the time shown the microlasers 42 are inactive while the microlaser 44 is active and directs light onto the group of molecules 50. It may be stressed at this point that the support 48 is transparent in this example of embodiment but that the support need not necessarily be transparent since exciting light source and detector can be arranged on one and the same side of the support, namely on the side on which the molecules to be studied are located.

In order to detect any luminescence reactions an array 54 comprising a number of detectors 56, 58 is provided in this example of embodiment. This allows excitation and detection to be separated especially easily by “switching off” the detector(s) 58 located in the direct region of radiation of an active laser 44, i.e. causing excitation of the molecules, during emission of the laser, e.g. in such a way that any radiation incident on the detector or detectors is not longer detected or signals from the relevant detectors are not passed on or evaluated. The other detectors 56 can, preferably under pulsed irradiation, likewise be switched off for the duration of the excitation phase but this is not absolutely necessary. In particular, between the array 54 of detectors and the support 48 it is possible to insert a wavelength filter 60 which filters out the radiation 62 at the wavelength of the exciting laser or at least severely attenuates it (as indicated by the rays 62′) while allowing the luminescence radiation 64 to pass so that this can be detected by the active detectors 56 and converted into corresponding signals which can then be passed on to an inherently known signal evaluation device which is thus not described further here, e.g. a computer.

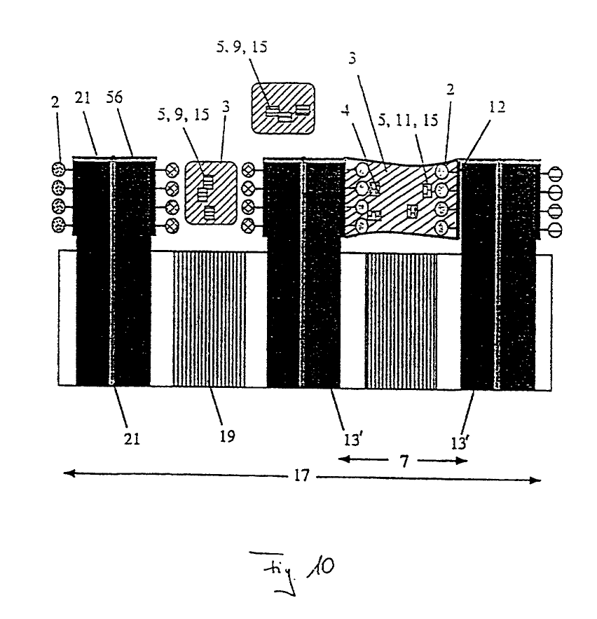

If a very precise resolution of individual image points on the support is required for the synthesis and readout of a highly complex molecule library, for example, a support shown in FIG. 2 can be connected securely (but not undetachably) to an array of microlasers before a lithographic synthesis of a molecule library and remain thus during the synthesis and staining with a second substance (for example, blood serum from patients) until the luminescence reaction is read out. The support can then be removed and a new support connected securely to the array of microlasers. In addition, an array of detectors can be connected securely to the array of microlasers as shown in FIG. 10.

Alternatively there can be inserted on the support at regular intervals so-called “guide dots”, which each give a defined luminescence signal and thus take over the function of the pits on the CD, i.e., give an internal grid which serves as position information.

Decoupling of excitation and detection is even easier in these examples than in the example using a CD as support since one microlaser after the other can be activated. For example, a fairly coarse grid of photodiodes can be constructed over the array whereby in each case the diode is switched off at the intensity maximum of the active exciting laser.

If the power of the laser or lasers is controllable, the laser(s) can also be used to detach selected molecules from the support whereby the detached molecules can then be suitably fed to another examining device, e.g. a mass spectrometer.

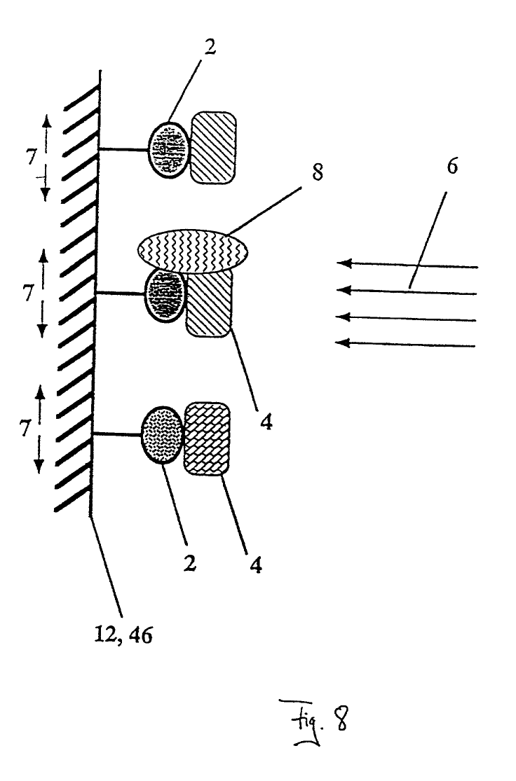

FIG. 8 shows once again as an example the basic principle of the proposed method of examination: selected regions 7 of a support 12 with molecules or aggregates 4 of these molecules linked to them or with molecules 8 which interact with the linked molecules 2 or with aggregates of these molecules 4, are exposed to electromagnetic waves 6.

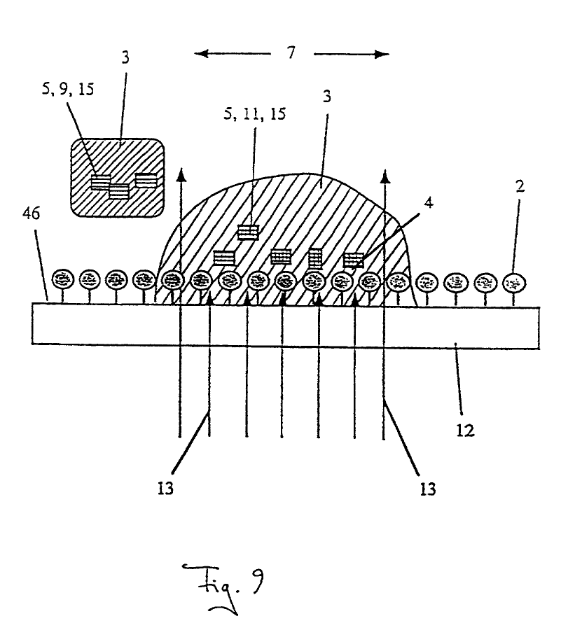

FIGS. 9 and 10 show schematically how the physical environment, especially the matrix layer 3 of substances 5 in locally narrowly defined regions 7, can be modified by the action of electromagnetic waves 13 (FIG. 9) or by the application of a voltage 13′ (FIG. 10) so that the previously immobilised substances 9 become mobilised (mobilised substances are indicated by 11) and can move into the vicinity of the support 12. There they can link to molecules 2 located on the support (form linkages), form an aggregate or become part of some other chemical reaction. FIG. 10 also shows that the support 12 can be embedded in a mixing array 17 of detectors 56 and purposefully controllable sources of electromagnetic radiation, e.g. light-emitting diodes 19. Selected regions 7 of the support 12 are more appropriately separated from one another by a non-conducting insulator 21 which is non-transmitting for the incident electromagnetic waves.

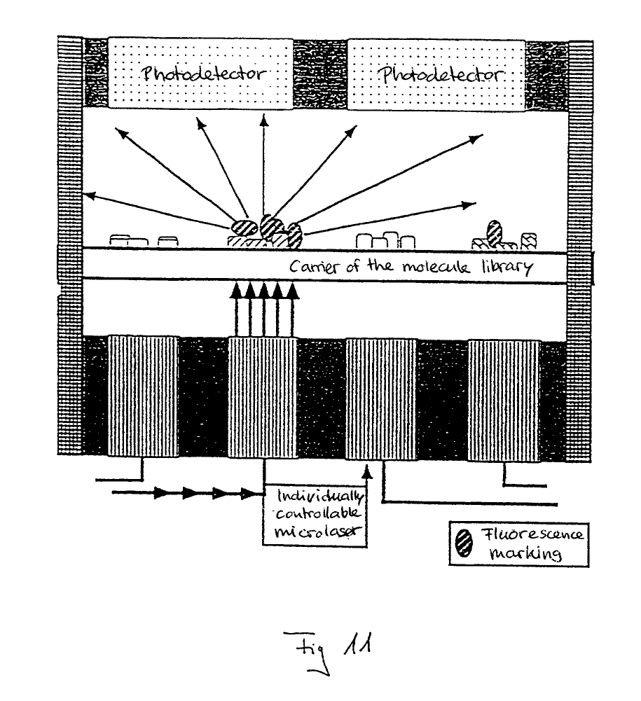

As shown in FIG. 11, selected regions of a support fixed above an array can be irradiated repeatedly with point precision using an array of individually controllable microlasers. By this means molecules of a molecule library can be applied to selected regions of the support using lithographic methods. After staining the molecule library with a fluorescence dye, the fluorescent molecules are excited in successively selected regions using a short light pulse. The radiation produced by the fluorescence of the molecules between the exciting pulses is collected by the photodetectors and can be assigned to individual members of the molecule library so that it can be determined precisely at which molecules fluorescence reactions have been induced.

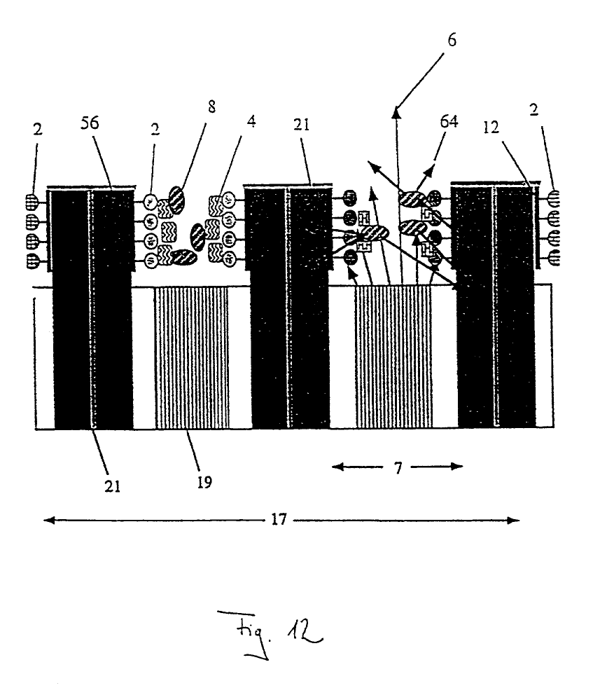

In a suitably designed mixing array 17 of individually controllable light sources 19 and detectors 56, as shown in FIG. 12, the detectors 56 themselves can be supports 12 of various molecules 2, 4 and 8. Such a mixing array 17 can, for example, be used to trigger combinatorial molecular synthesis in selected regions 7, to excite selected regions 7 briefly with electromagnetic waves 6 and to measure directly any luminescence reactions arising under such excitation. The detectors 56 can especially be silicon supports, light-emitting diodes or an independent array of detectors. In order to separate the regions 7 from one another there is provided a non-conducting insulator 21 which is non-transmitting for the incident electromagnetic waves.

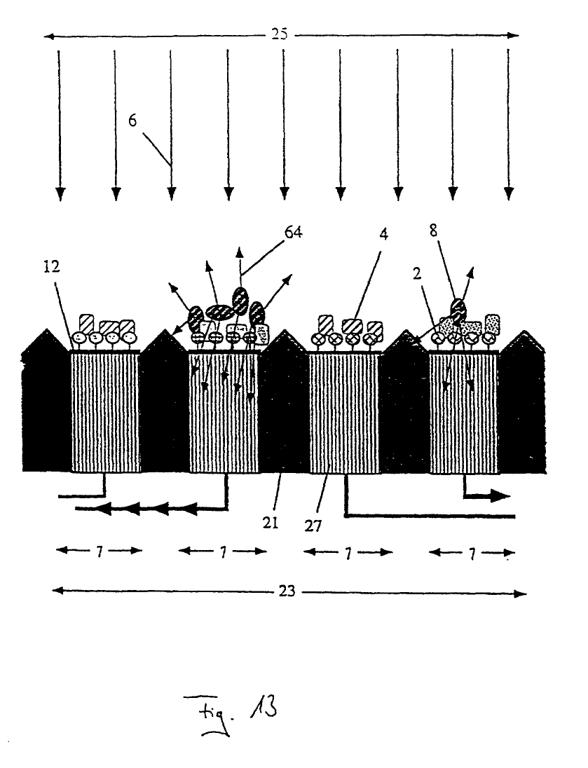

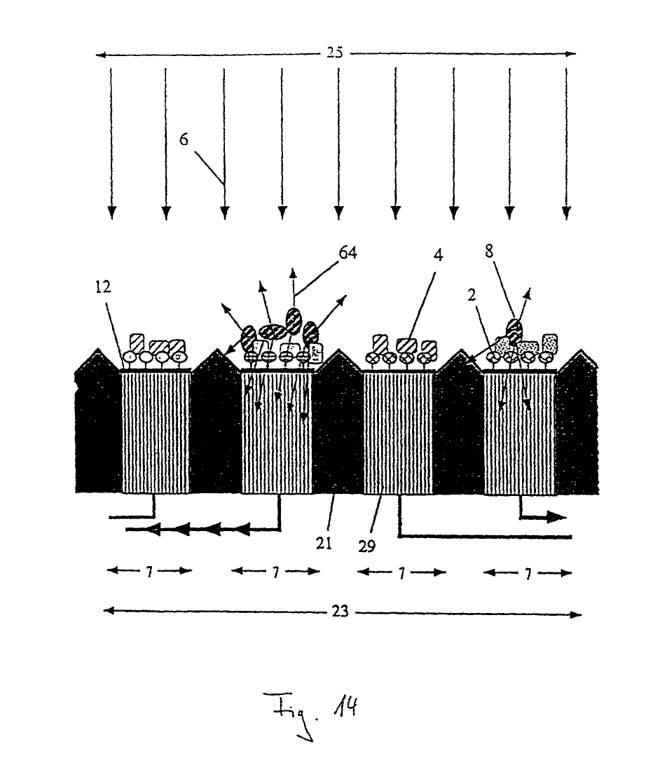

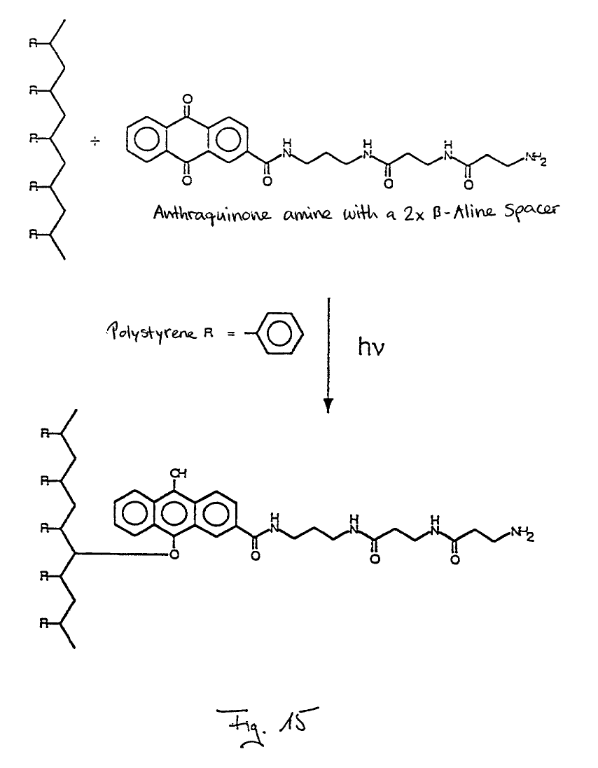

FIGS. 13 and 14 show schematically how an array 23 of individually controllable detectors 27 (FIG. 13) which can be supports 12 of various molecules 2, 4 and 8 or an array of individually controllable light-emitting diodes 29 (FIG. 14) which can also be used as photodetectors can be used to trigger combinatorial molecular synthesis in selected regions 7, to excite larger regions 25 or selected regions 7 briefly with electromagnetic waves 6 and to measure directly any luminescence reactions occurring under such excitation in the dark phases of the excitation. Especially silicon supports can be used as detectors 27 (FIG. 13). In order to separate the regions 7 from one another there is again provided a non-conducting insulator 21 which is non-transmitting for the incident electromagnetic waves.

Some examples of the implementation of the method according to the invention or the application of the devices according to the invention are described subsequently:

a) Synthesis of a Complete 6-mer Peptide Library on a CD Under Anhydrous Conditions

The surface of a CD is coated with a plastic layer which contains free amino groups for the solid-phase synthesis. After linking a suitable spacer of 2-3 amino acids length with the aid of standard fMoc peptide synthesis, free amino acids are then blocked with a light-detachable protective group. The protective group to be linked is fed through a tube onto the inside of the rotating CD. For this a slightly modified synthesis program of an inherently known peptide synthesiser can be used. A program which controls the activity of a burning laser detaches the protective groups at the regions where the amino acid alanine is to be linked in the first step. The protective group is detached by two-photon activation using a burning laser and a slightly less-focussed second laser which irradiates from above. After the selective detachment of the protective group, the activated amino acid alanine is fed through the aforesaid tube to the CD. The activated amino acid links to the free amino groups whereby the own amino group of the amino acid has previously been blocked by the same protective group as mentioned above. This process is repeated for the other 19 amino acids and the whole is repeated a total of six times. In the last step the protective groups are detached from all synthesised peptides.

b) Synthesis of a Complete 5-mer Peptide Library Using an Array of Microlasers

A suitable flat transparent support containing free amino acids is fixed securely above the array of microlasers. Especially suitable here are thin glass disks which are cleaned with concentrated NaOH, then washed with water and derivatised for 2 hours at room temperature using 10% (vol/vol) bis(2-hydoxyethyl) aminopropyltrioxysilane. Alternatively a suitable flat transparent support can be coated with a plastic layer which contains free amino groups for the solid-phase synthesis.

With the aid of standard fMoc peptide synthesis under anhydrous conditions familiar to the specialist a suitable spacer of 2-3 amino acids length is first synthesised at the free amino groups.

Then the support is divided parallel to the X axis into 20 separate regions which are wetted by the 20 different activated fMoc derivatives of the amino acids each dissolved in DMF.

Linking of the activated amino acids then takes place at room temperature for 30-60 minutes. After washing three times with dimethyl formamide (DMF) the fMoc protective group is detached using 20% piperidine in DMF and then washed again with DMF.

The support is again divided into 20 separate regions, this time parallel to the Y axis. These regions are again wetted by the 20 different activated fMoc derivatives of the amino acids, each dissolved in DMF, followed by the standard fMoc peptide synthesis under anhydrous conditions familiar to the specialist as described above.

After detaching the N-terminal protective group as described above, at this stage the support described above is divided into 400 separate regions, each having one of 400 possible C-terminal dipeptides linked to the support through a spacer, whose N-terminal is free, i.e. has no protective group.

For the next linking step the activated amino acids described above are dissolved individually, instead of in DMF, in a suitable solvent which is liquid at 50° C. and solid at 4° C., a suitable laser-light-absorbing additive which is inert with respect to the activated amino acids, especially a dye or graphite particles, is added, the solution is deep-frozen and pulverised into small particles.

These particles are dusted at 4-10° C. on the support mounted securely above an array of microlasers, a cover plate is placed thereover and selected regions are irradiated for 20-30 minutes using the microlasers. The absorption of laser light by the added dye thereby heats the solvent frozen at the selected temperatures locally in the irradiated regions and thus makes it possible to link the activated amino acids to the free amino groups exclusively in these regions. Then the cover plate is removed and the non-linked amino acids are washed away with DMF, whereby this washing process is repeated twice with heated DMF.

This process is repeated a total of 20 times with all activated amino acids so that the 400 separately defined regions described above are divided into 20×400 defined regions, followed by the detachment of the fMoc protective groups using 20% piperidine in DMF described above.

Lengthening of the peptides by a fourth and fifth amino acid then takes place by analogy with the synthesis of the third amino acid whereby, as described above, each region is divided into 20 regions at each synthesis step.

Finally all protective groups are detached using 10% silane in concentrated trifluoroacetic acid, the support is washed with DMF and methanol and dried so that in the end effect a support with 20⁵=3,200,000 different regions is formed, each representing one of all the possible C-terminal-linked pentapeptides.

c) Examination of Blood Serum Using a Compact Disk with a Peptide Library Fixed to it

The CD is stained with the blood serum of a patient for which initially non-specific linkages are blocked with a suitable aqueous solution, such as for example 2% milk powder in PBS and the blood serum is diluted in the same buffer whereupon the surface of the CD is then wetted with the serum while shaking gently for 60 minutes. The CD is washed three times. The goat anti-human antibody linked to the dye Cy5 is diluted in 2% milk powder in PBS; the surface of the CD is then wetted while shaking gently for 60 minutes and then washed three times. The compact disk stained with the second antibody is read out in a modified CD player.

d) Readout of a Stained Compact Disk Using a Modified CD burner

A burning laser set to low wattage scans the CD in the first run. Thereby any fluorescence signals are detected with the aid of additional optics built into the CD burner and assigned to the various CD regions. This additional optics consists of a focussing lens which images one or, if desired, several pits on a photomultiplier or a CCD camera. The lens thereby images a point in the running direction of the CD outside the maximum of the irradiating laser. In addition the scattered laser light is separated from the fluorescence signal by a suitable edge filter. The regions of the CD which yielded a signal in the first run are purposefully located and multiply scanned in the following passes. The signals read off are added and assigned to the positive pits.

e) Examination of Blood Serum Using a Support with a Peptide Library Fixed to it

As described in example c), in this example the support mounted securely on an array of microlasers with a lithographically synthesised complete pentapeptide library described in example b) is blocked with a suitable aqueous solution, preferably 2% milk powder in PBS, incubated with the diluted blood serum from patients and then stained with a Cy5 linked goat anti-human antibody.

Then one microlaser at a time is switched on sequentially one after the other and light emitted by any bound fluorescence molecules is read out using a coarser grid of photodiodes over the array of microlasers, whereby in each case the diode is switched off at the intensity maximum of the exciting laser which is presently active (see FIG. 2). The scattered light produced by the exciting laser is additionally separated from the fluorescence light by a suitable wavelength filter.

In order to improve the signal/noise ratio still further, the irradiating microlaser can be pulsed whereby the detection of the fluorescence signal takes place in the dark phases of the irradiating laser.

The fluorescence signals are divided into a total of 10 different brightness steps which are assigned to the individual microlasers (i.e., in this case the different pentapeptides).

The microlasers which yielded the highest fluorescence signals in a first run can then be used many times one after the other for excitation after which the fluorescence signals obtained are determined.

f) Synthesis of a Complete 12-mer Oligonucleotide Library on a Support with the Aid of an Array of Microlasers

As described in example b) for the synthesis of a complete 5-mer peptide library, a suitable flat transparent support with free amino groups is used.

If not already present as a result of the first step, standard synthesis under anhydrous conditions familiar to the specialist is used to synthesise a suitable linker at the free amino groups which again anchors free amino groups on the support which this time however are approximately 22 atoms away from the surface.

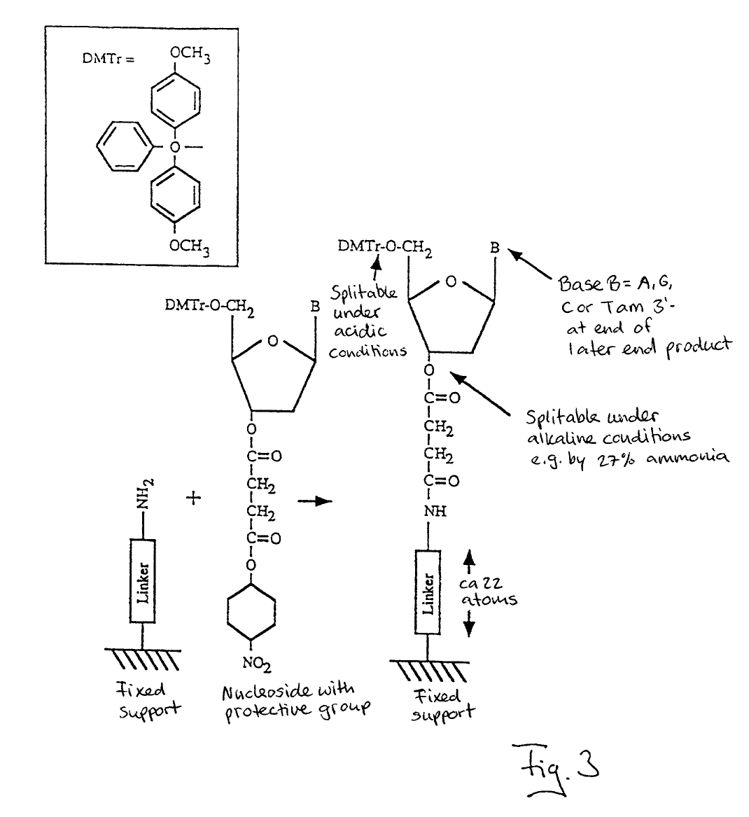

The support is then divided into four separate regions parallel to the X axis which are wetted by four different activated nucleoside anhydrates with protective groups. The nucleosides then link to the free amino groups (FIG. 3). Instead of the base-detachable linker, a linker which is stable under these conditions can also be used.

The linking of the activated nucleosides (with protective groups) to the solid support, the detachment of the protective groups and the washing steps take place under standard conditions for oligonucleotide synthesis familiar to the specialist. Examples for the protective groups used are:

DMTr for the 5′ end of the nucleoside (FIG. 3)

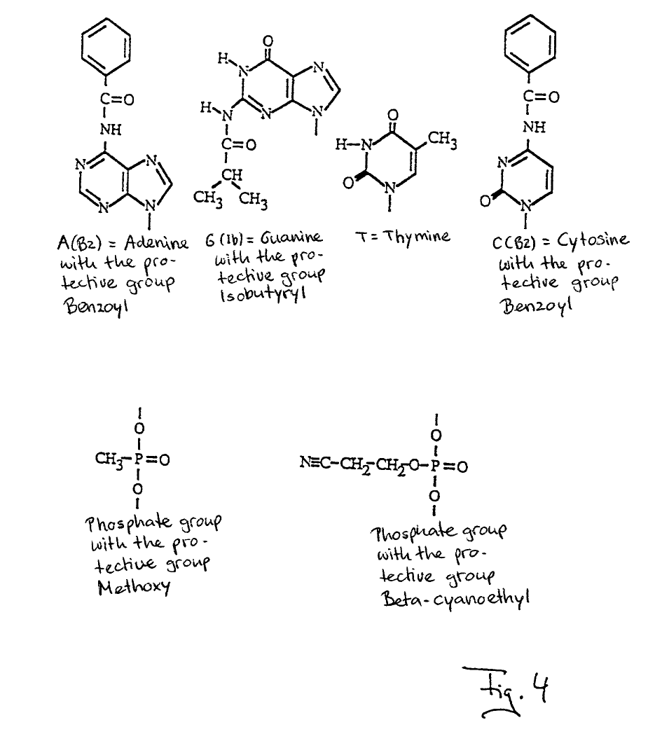

Benzoyl for the bases adenine and cytosine (FIG. 4)

Isobutyryl for the base guanine (FIG. 4)

Methoxy or betacyanoethyl for the phosphate groups (FIG. 4).

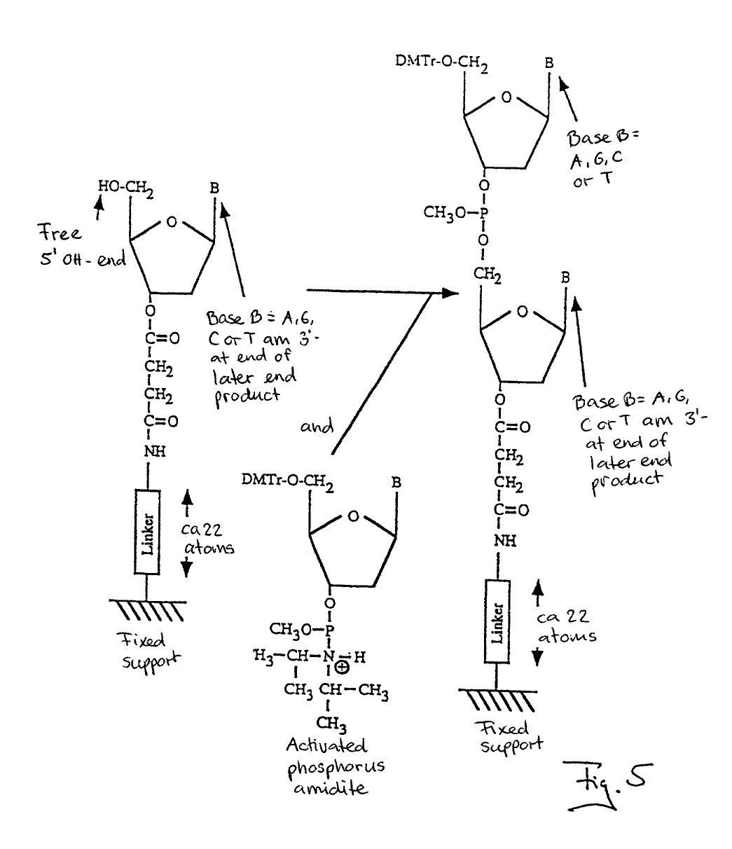

After detaching the DMTr protective group from the 5′ end of the nucleoside, at the next step the support is again divided into four separate regions which this time run parallel to the Y axis. These regions are this time wetted by the four different phosphoramidite derivatives activated using a weak acid such as tetrazole. As a result of the linkage of the activated phosphoramidite to the free 5′-OH end, the chain is lengthened by a base (FIG. 5).

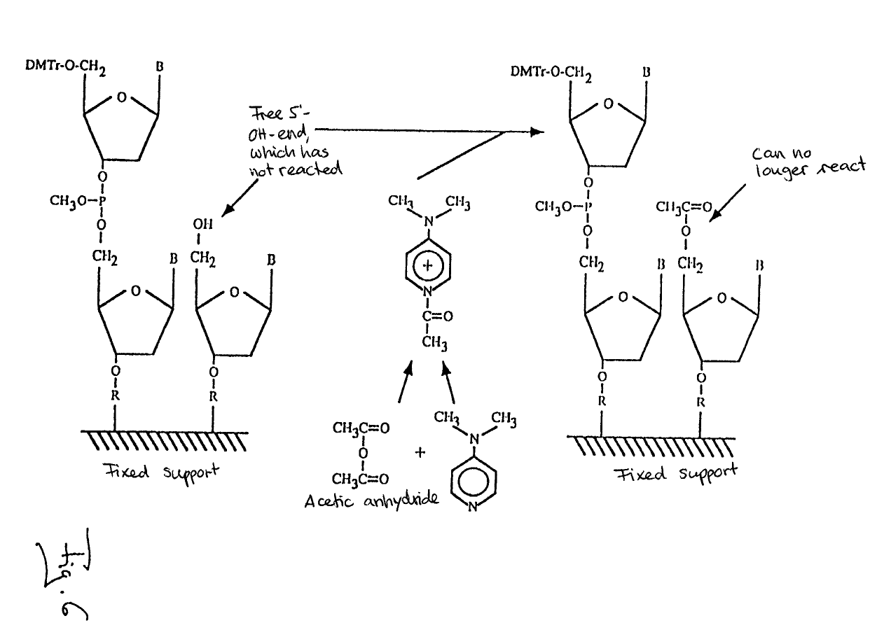

At the next step any remaining free 5′-OH ends are provided with a “cap” so that they can no longer participate in later reactions (FIG. 6).

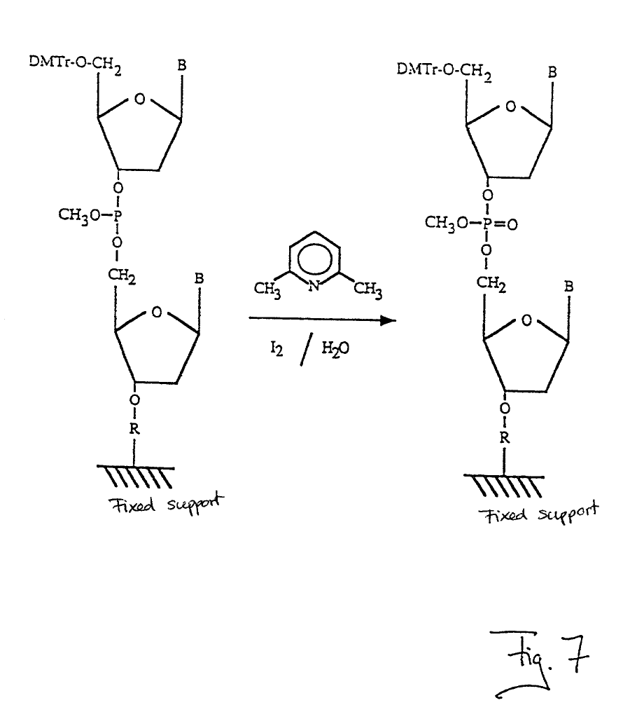

A last step in which the trivalent phosphate groups are oxidised concludes the synthesis cycle (FIG. 7).

The synthesis described above corresponds to the standard oligonucleotide synthesis familiar to the specialist. Unlike the familiar standard synthesis, however, the oligonucleotides are anchored to the solid support such after the concluding complete detachment of the protective groups they cannot be detached from the support but remain linked to the support.

Then the DMTr protective groups are again detached from the 5′-OH end using TCA such that on the support described above at this stage there are 16 divided separately defined regions, each with one of 16 possible dinucleotides linked to the support via the 3′-end through a spacer whose 5′-end has a free OH-group.

For the next linking step the activated phosphoramidite derivatives described above are dissolved, instead of in acetonitrile, in a suitable solvent which is liquid at 50° C. and solid at 4° C., a suitable laser-light-absorbing dye which is inert with respect to the activated nucleosides is added, especially graphite particles, the solution is deep frozen and pulverised into small particles.

These particles are dusted at 4-10° C. on the support, mounted securely above an array of microlasers, a cover plate is placed thereover and selected regions are irradiated for 20-30 minutes using the microlasers. The absorption of laser light by the added dye thereby heats the solvent frozen at the selected temperatures locally in the irradiated regions and thus makes it possible to link the activated phosphoramidite derivatives to the free 5′-OH ends exclusively in these regions. Then the cover plate is removed and the non-linked phosphoramidite derivatives are washed away with cold acetonitrile. This washing process is then repeated twice with heated acetonitrile.

This process is repeated a total of 4 times with all activated phosphoramidite derivatives so that the 16 separate regions described above are divided into 4×16 defined regions, followed by the “capping” of the remaining free 5′-OH ends described above, oxidation of the trivalent phosphate groups and renewed detachment of the DMTr protective groups with TCA.

Lengthening of the oligonucleotide by another nine bases then takes place by analogy with the synthesis of the third base whereby, as described above, at each synthesis step each region is divided into four defined regions.

Finally all protective groups are detached using dichloromethane and trichloroacetic acid, the support is washed with acetonitrile and dried so that in the end effect a support with 4¹²=16,777,216 different regions is produced which each represent one of all possible 12-mer oligonucleotides linked via the 3′-end.

g) Examination of Patient DNA Using an Array of Microlasers with a 12-mer Oligonucleotide Library Fixed to a Support

The support described under example f) with a complete oligonucleotide library fixed to it is stained with patient DNA. Non-specific linkages are saturated, for example, with DNA from herring spermatozoa.

A tumour tissue sample and at the same time a healthy tissue sample are taken from the patient and the genomic DNA contained therein is multiplied using one or several pairs of tumour-specific primers (specific, for example, for the genes of p53, p16, ras, c-myc, n-myc) in a polymerase chain reaction. FITC-marked dNTPs are incorporated into the tumour sample or the normal sample is marked with biotinylated dNTPs, the samples are mixed and hybridised on the support. The hybridised sample is then stained with a chemically linked protein of streptavidin and phycoerythrin to which the fluorescence dye Cy5 was additionally linked. By this means two different fluorescences can be measured with one exciting wavelength.

As described in example e), one microlaser at a time is then switched on sequentially one after the other and light emitted by any bound fluorescence molecules is read out using a coarser grid of photodiodes over the array of microlasers whereby in each case the diode is switched off at the intensity maximum of the exciting laser which is presently active. The scattered light produced by the exciting laser is additionally separated from the fluorescence light by a suitable wavelength filter. The wavelength filter is tuned on the one hand to the fluorescence dye FITC and on the other hand to the tandem dye phycoerythrin-Cy5 (PE-Cy5).

The fluorescence signals are then each divided into a total of ten different brightness steps which are assigned to the various microlasers (i.e., in this case the various oligonucleotides).

The microlasers which yielded a strikingly different ratio of FITC staining to PE-Cy5 staining compared to the other image points in a first run are then used repeatedly one after the other for excitation, after which the fluorescence signals obtained are summed and the ratio of FITC staining to PE-Cy5 staining is determined again.

In this way point mutations in genes which are important for the prognosis of tumour diseases can be diagnosed. Unlike the systems on the market, many genes can be analysed at the same with a complete 12-mer oligonucleotide library.

In an alternative embodiment, DNA taken from the patient is used as a template for multiplication with so-called Alu primers which hybridise at the edges of repetitive Alu sequences which occur very frequently in the genome and multiply non-repetitive DNA lying between two Alu sequences. Again FITC-marked dNTPs are incorporated in the tumour sample or biotinylated dNTPs in the normal sample and the samples mixed on the support are hybridised.

The fluorescence signals are then read out as described above. In this way, the complete genome is scanned for differences between normal and tumour tissue whereby new diagnostic markers can be discovered which carry important information for the tumour progression.

h) Combination of the Fluorescence Detector According to Example d) with a Mass Spectrometer

The fluorescence detector according to example d) or only the CD burner section without additional fluorescence optics is surrounded with a vessel which can be evacuated. The focal point of the burning laser is situated at the position of the normal sample holder of a mass spectrometer. The burning laser can locate arbitrary points on the CD and blast away the molecules located there which can then be investigated using the mass spectrometer.

Such a combined device allows an analysis to be made of the binding pairs which form when two highly complex molecule libraries combine whereas in the techniques known so far it is only possible to combine and analyse two molecule libraries together which are several orders of magnitude less complex.

Instead of a mass spectrometer a movable device can also be used with which phages or DNA can be recovered from individual pits of the CD.

i) Sequencing of Complex DNA Using Solid-phase Linked Oligos

The complete 12-mer oligonucleotide library described in example f) is used. Unlike example f) however, the direction of synthesis must “turned around” here, i.e. the detachable protective group similar to DMTr must be positioned for this at the 3′-OH end so that a solid-phase-linked oligonucleotide library with free 3′ ends is present at the end. The hybridisation conditions are selected such that only very few, if any, mismatches occur between the oligonucleotides and the templates hybridised thereon. The complexity of the solid-phase-linked oligonucleotides should exceed that of the DNA to be sequenced. Non-hybridised cDNA is washed away. A Sanger sequence reaction is carried out with comparatively many ddNTPs in the reaction solution so that on average the oligoprimer is lengthened by an average of 20 nucleotides. After this the template is detached again by heating. Then the sequence information is read out in the combined CD burner-mass spectrometer described in example h) whereby the burning laser vaporises selected oligonucleotides lengthened by the sequence reaction so that the sequence information can then be detected using the mass spectrometer.

j) Repeated Staining of a Large Number of Defined Lymphocytes

Lymphocytes are obtained from human blood serum using standard methods and fixed using standard methods (0.37% paraformaldehyde in PBS). Approximately 10⁸ lymphocytes thus fixed are distributed on the surface of a CD or a fluorescence multilayer disk (FMD) and there fixed to the surface.

The FMD or CD is then placed in a tightly-closing rubber tourniquet and non-specific linkages blocked using 5% milk powder in PBS.

Approximately 150 different monoclonal antibody are conjugated individually with fluorescence markings, including for example, EGFP, EBFP, EYFP, Cy3, Cy5, Cy5.5 and Cy7. Optionally the corresponding Fab fragments can thus be prepared beforehand. A characteristic of the conjugated monoclonal antibodies is that they recognise various surface antigens of human lymphocytes including CD antigens, receptors for growth hormones, apoptosis-associated proteins and homing receptors.

The lymphocytes fixed on the FMD or CD are then incubated with the fluorescence-marked monoclonal antibodies (60 minutes at 37° C. in 5% milk powder in PBS and 0.5% Tween 20). For staining the fixed lymphocytes 2 to 5 antibodies conjugated with different fluorescence are preferably used in each case. After unbound antibodies have been removed by washing three times with PBS, the CD or FMD is inserted in an essentially commercially available CD or FMD drive and played back. The playback time is divided into >10⁸ different time units on the basis of the integrated position markings (repeatably and controllably). During each of these time units the laser beam used for scanning detects fluorescent molecules located on the surface (i.e. antibodies binding the lymphocytes). The fluorescence light is broken down into various colour components and preferably detected using the principle of the confocal laser microscope. A fluorescence intensity is thus assigned to each time unit (under certain circumstances repeatably) and saved, preferably several different fluorescences simultaneously.

The FMD or CD is then removed, the fluorescences located on it are bleached by irradiation with very high-intensity light and, as described above, it is stained again with other fluorescence-marked antibodies. As described, the fluorescence intensities are again assigned to the time units (which have remained the same). Repeating this process many times assigns to each time unit up to 150 different signal intensities corresponding to said monoclonal antibodies.

The signal intensities assigned to a time unit are assigned to various cell categories and the number of appropriate cell categories is determined (CD3 is, for example, characteristic of a T-lymphocyte, CD4 defines T-helper cells, CD8 cytotoxic T-cells, CD19 is characteristic of B-lymphocytes of a defined differentiation stage and so on).

k) Diagnosis of Lymphocytes

The staining of lymphocytes described in example j) is carried out using blood cells of clinically unremarkable patients. The signal patterns obtained are compared with the signal patterns obtained on staining the blood cells of patients with diagnosed Crohn's disease, heart attack, Parkinson's disease, multiple sclerosis, lymphoma, especially preclinical lymphoma or systemic Lupus erythermatodes.

While the invention has been illustrated and described as embodied in a method and device for detecting optical properties, especially luminescence reactions and refraction behavior of molecules which are directly or indirectly bound on a support, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A method for detecting optical properties, especially luminescence reactions and refraction behavior, of molecules bound directly or indirectly on a support, whereby electromagnetic waves, especially laser light is directed onto the support and light emitted or refracted by the molecules is detected by a detector and whereby detector and support are moved relative to one another during or after the exposure to the electromagnetic waves, wherein a support, especially a transparent support with integrated position markings which can be detected by a detector, especially an optoelectronic scanning system is used and at least one of the integrated position markings is read out during or after the relative movement of the support and detector so that the light detected by the detector can be assigned to a location on the support.

2. The method of claim 1, wherein the relative movement of the support and detector is produced by rotating the support.

3. The method of claim 1, wherein a suitably modified, especially transparent compact disk (CD), digital versatile disk (DVD) magneto optical disk (MOD) or fluorescence multilayer disk (FMD) of the type available commercially with respect to the position markings is used.

4. The method of claim 1, wherein a support is used to which is applied at least one element of the group consisting of molecule libraries, cells, cell fragments, cells or cell fragments grown adherently on the support, tissue, tissue sections, cells or tissue pieces attached by embedding in a gel-like matrix, especially agar, agarose, polyacrylamide or gelantine attached to the support.

5. The method according to claim 1, wherein the optical properties are measured repeatedly at a specific site on the support.

6. The method of claim 1, wherein the molecules whose optical properties are to be detected, can be exchanged or modified at each site on the support and especially after exchanging the molecules or modifying the molecules new measurements can be made.

7. The method of claim 6, wherein the process of exchanging or modifying molecules whose optical properties are to be detected can be repeated arbitrarily frequently.

8. The method of claim 6, wherein a characteristic profile can be compiled for a specific location of the material applied to the support, especially cells or histological sections.

9. The method of claim 1, wherein the optical properties of several different molecules at a specific site can be measured simultaneously.

10. The method of claim 1, wherein the selected molecules or the biological structures carrying the selected molecules, especially liposomes, virus particles, retroviruses, bacteriophages, viroids, cell fragments, especially B-lymphocytes, T-lymphocytes, leucocytes, parasites, single cells or bacteria, are detached from the support especially by exposure to electromagnetic waves, especially laser light, and are supplied to a method for detecting other, not necessarily optical properties.

11. The method of claim 10, wherein the detachment of the selected molecules or the biological structures carrying the selected molecules takes place by interaction of the electromagnetic waves with a preferably meltable or photosensitive substance provided between the support and the molecules or the biological structures.

12. The method of claim 1, wherein optical properties of the molecules are achieved by applying a dye which links to the molecules or the biological structures carrying the molecules as appropriate, wherein another dye is applied to the support and that the optical properties of the molecules change as a result of fluorescence energy transfer from one dye to the other.

13. The method of claim 1, wherein the support is rotated, wherein the optical properties of the biological structures, especially of molecules, cell fragments or cells, or dyes bound to them are determined after the biological structures or the fluorescence dyes have migrated along an essentially radial direction to the axis of rotation of the support.

14. A device for detecting optical properties, especially luminescence reactions and refraction behavior, of molecules bound directly or indirectly on a support, comprising means for directing the electromagnetic waves, especially laser light, on the support; a detector for detecting light emitted or refracted by the molecules; and means for producing a relative movement of detector and support during or after the exposure to electromagnetic waves, wherein a detector, especially an optoelectronic scanning system is provided to detect position markings integrated in the support.

15. The device of claim 14, wherein the optoelectronic scanning system is a position detecting system of a CD, MOD, DVD or FMD drive.

16. A support for use in a method of claim 1.

17. The support of claim 16, wherein the support is a transparent CD, DVD, MOD or FMD, essentially of the type available commercially with respect to the position markings.

18. The support of claim 16, wherein a molecule library, preferably adherently grown cells or cell fragments, tissue or tissue sections are applied to said support or are embedded by embedding in a gel-like matrix attached to the support, especially agar, agarose, polyacrylamide or gelantine.

19. The support of claim 16, wherein between the molecules to be investigated and the actual support body there is provided a layer with meltable and/or photosensitive substances.

20. A method for detecting optical properties, especially luminescence reactions and refraction behavior, of molecules bound directly or indirectly on a support, whereby electromagnetic waves, especially laser light, is directed onto the support and light emitted or refracted by the molecules is detected by a detector and whereby detector and support are moved relative to one another during or after the exposure to the electromagnetic waves, whereby a support, especially a transparent support with integrated position markings which can be detected by a detector, especially an optoelectronic scanning system is used and at least one of the integrated position markings is read out during or after the relative movement of the support and detector so that the light detected by the detector can be assigned to a location on the support and the relative movement of the support and detector is produced by rotating the support and a suitably modified, especially transparent compact disk (CD), digital versatile disk (DVD) magneto optical disk (MOD) or fluorescence multilayer disk (FMD) of the type available commercially with respect to the position markings is used.

21. The method of claim 20, wherein a support is used to which is applied at least one element of the group consisting of molecule libraries, cells, cell fragments, cells or cell fragments grown adherently on the support, tissue, tissue sections, cells or tissue pieces attached by embedding in a gel-like matrix, especially agar, agarose, polyacrylamide or gelantine attached to the support.

22. The method of claim 20, wherein the optical properties are measured repeatedly at a specific location on the support.

23. The method of claim 1, wherein the molecules whose optical properties are to be detected, can be exchanged or modified at each location on the support and especially after exchanging the molecules or modifying the molecules new measurements can be made.

24. The method of claim 23, wherein the process of exchanging or modifying molecules whose optical properties are to be detected can be repeated arbitrarily frequently.

25. The method of claim 23, wherein a characteristic profile can be compiled for a specific location of the material applied to the support, especially cells or histological sections.

26. The method of claim 20, wherein the optical properties of several different molecules at a specific location can be measured simultaneously.

27. The method of claim 20, wherein the selected molecules or the biological structures carrying the selected molecules, especially liposomes, virus particles, retroviruses, bacteriophages, viroids, cell fragments, especially B-lymphocytes, T-lymphocytes, leucocytes, parasites, single cells or bacteria, are detached from the support especially by exposure to electromagnetic waves, especially laser light, and are supplied to a method for detecting other, not necessarily optical properties.

28. The method according to claim 27, wherein the detachment of the selected molecules or the biological structures carrying the selected molecules takes place by interaction of the electromagnetic waves with a preferably meltable or photosensitive substance provided between the support and the molecules or the biological structures.

29. The method of claim 20, whereby optical properties of the molecules are achieved by applying a dye which links to the molecules or the biological structures carrying the molecules as appropriate, wherein another dye is applied to the support and that the optical properties of the molecules change as a result of fluorescence energy transfer from one dye to the other.

30. The method of claim 20, whereby the support is rotated, wherein the optical properties of the biological structures, especially of molecules, cell fragments or cells, or dyes bound to them are determined after the biological structures or the fluorescence dyes have migrated along an essentially radial direction to the axis of rotation of the support.

31. A device for detecting optical properties, especially luminescence reactions and refraction behavior, of molecules bound directly or indirectly on a support, with means for directing the electromagnetic waves, especially laser light, on the support and a detector for detecting light emitted or refracted by the molecules as well as means for producing a relative movement of detector and support during or after the exposure to electromagnetic waves, whereby a detector, especially an optoelectronic scanning system is provided to detect position markings integrated in the support and the optoelectronic scanning system is a position detecting system of a CD, MOD, DVD or FMD drive.

32. A support for use in a method of claim 1, whereby the support is preferably a transparent CD, DVD, MOD or FMD, essentially of the type available commercially with respect to the position markings, on which a molecule library, adherently grown cells, cell fragments, tissue or tissue sections are either applied or are embedded in a gel-like matrix attached to the support, especially agar, agarose, polyacrylamide or gelantine.

33. The support of claim 32, wherein between the molecules to be investigated and the actual support body there is provided a layer with meltable and/or photosensitive substances.
